(19) United States
(12) Patent Application Publication
(10) Pub. No.: US 2025/0239798 A1
(43) Pub. Date: Jul. 24, 2025

(54) ELECTRICAL CONNECTOR

(71) Applicants: APTIV CONNECTION SYSTEMS (NANTONG) LTD., Jiangsu (CN); APTIV ELECTRICAL CENTERS (SHANGHAI) CO. LTD., Shanghai (CN)

(72) Inventors: Xiaoxian TIAN, Shanghai (CN); Haifei GUAN, Shanghai (CN)

(21) Appl. No.: 19/034,705

(22) Filed: Jan. 23, 2025

(30) Foreign Application Priority Data
Jan. 23, 2024 (CN) 202410099153.X

(51) Int. Cl. H01R 13/436

(52) U.S. Cl. CPC H01R 13/4361

(57) ABSTRACT

An electrical connector includes a shell component with a plastic housing featuring multiple terminal cavities, each containing electrical terminals. The plastic housing is equipped with multiple housing clamping arms corresponding to the terminal cavities, including first housing clamping arms on the left and right sides, and second housing clamping arms on the upper and lower sides. A terminal position assurance (TPA) device is mounted onto the left and right sides of the plastic housing. Each TPA device applies force to both the first and second housing clamping arms, causing them to deform inwardly towards the interior of the plastic housing, thereby securing the electrical terminals within the cavities.

### CROSS-REFERENCE TO RELATED APPLICATION

This application claims benefit of priority to Chinese Patent Application No. 202410099153.X filed on Jan. 23, 2024, the entire disclosure of which is hereby incorporated by reference.

### TECHNICAL FIELD OF THE INVENTION

This application relates to electrical connector, including but not limited to the field of coaxial connector technology.

### BACKGROUND

Traditional electrical connectors have typically employed a variety of mechanisms to ensure secure terminal positioning and reliable electrical connections. One common approach involves the use of a single-piece plastic housing with integrated terminal cavities to hold electrical terminals in place. These housings often rely on friction or simple mechanical interference to maintain terminal position, which can be insufficient in applications subject to vibration or mechanical stress. As a result, electrical terminals may become loose or misaligned, leading to potential connection failures.

Another approach has been the incorporation of additional components, such as terminal position assurance (TPA) devices, which are designed to enhance the retention of electrical terminals within the connector housing. These TPA devices are often separate components that are inserted or attached to the housing after the electrical terminals have been positioned. While these devices can improve terminal retention, they often require precise alignment and additional assembly steps, which can increase manufacturing complexity and cost. Furthermore, traditional TPA devices may not provide uniform pressure across all electrical terminals, potentially leading to uneven retention forces.

Some designs have attempted to address these issues by integrating flexible clamping arms within the connector housing itself. These clamping arms are intended to apply pressure to the electrical terminals, securing them in place. However, such designs often lack the ability to apply consistent force across multiple axes, which can result in inadequate terminal retention under certain conditions. Additionally, the integration of clamping arms into the housing can complicate the molding process and limit design flexibility.

However, none of these approaches have provided a comprehensive solution that combines the features described in this disclosure.

At present, when developing an electrical connector having multiple terminal positions, multiple terminal position assurance (TPA) devices are usually mounted on the connector housing to achieve the purpose of keeping the inserted electrical terminals in position. For example, for an electrical connector having six terminal positions, up to three TPA devices are required to achieve terminal position assurance. In addition, multiple TPA devices configured to be used for the same connector may be different in size, structure and function, resulting in an increase in the number of molds used to produce locking components.

### SUMMARY

This application is directed to solving the above problems by proposing an electrical connector, which is configured to achieve the effect of terminal position assurance with a reduced number of TPA devices.

According to an aspect of this application, an electrical connector is provided. The electrical connector includes a shell component including a plurality of terminal cavities to contain electrical terminals. The shell component includes a plastic housing formed with multiple housing clamping arms. The multiple housing clamping arms corresponding to the plurality of terminal cavities, respectively. The multiple housing clamping arms include a first housing clamping arm formed on left side and right side of the plastic housing and a second housing clamping arm formed on upper side and lower side of the plastic housing. The electrical connector also includes a terminal position assurance (TPA) device configured to be mounted onto the left side and right side of the plastic housing of the shell component. Each TPA device is configured to apply a force to both the first housing clamping arm and the second housing clamping arm, such that both the first housing clamping arm and the second housing clamping arm are deformed towards the inside of the plastic housing.

In the above-mentioned solution of electrical connector, optionally, the plurality of terminal cavities include a first terminal cavity and a second terminal cavity. The first housing clamping arm is provided adjacent to the first terminal cavity and the second housing clamping arm is provided adjacent the second terminal cavity.

In the above-mentioned solution of electrical connector, optionally, the TPA device is configured to push the first housing clamping arm configured to bend so as to enter into the first terminal cavity and is configured to push the second housing clamping arm configured to bend so as to enter into the second terminal cavity.

In the above-mentioned solution of electrical connector, optionally, the plurality of terminal cavities are consisting of an upper row and a lower row. Each row of terminal cavities include a first terminal cavity at the leftmost position, a first terminal cavity at the rightmost position, and a second terminal cavity between first terminal cavities.

In the above-mentioned solution of electrical connector, optionally, the plurality of terminal cavities have six terminal cavities arranged in upper row and lower row. Each row of three terminal cavities includes a first terminal cavity at the leftmost position, a first terminal cavity at the rightmost position, and a second terminal cavity at the middle position.

In the above-mentioned solution of electrical connector, optionally, the TPA device includes a first TPA device configured to be mounted on a left side of the plastic housing of the shell component, and a second TPA device configured to be mounted on a right side of the plastic housing of the shell component. The first TPA device is configured to push a second housing clamping arm on one of the upper side and lower side of the plastic housing and the second TPA device is configured to push a second housing clamping arm on another one of the upper side and lower side of the plastic housing.

In the above-mentioned solution of electrical connector, optionally, the TPA device is configured to apply interference to an electrical terminal in the first terminal cavity so as to prevent the electrical terminal from exiting.

In the above-mentioned solution of electrical connector, optionally, the TPA device includes a substrate, and an extension pressing arm formed at an edge of the substrate, when the substrate of the TPA device is mounted at a left side or right side of the plastic housing, the extension pressing arm is configured to apply a force to the second housing clamping arm configured to bend the same.

In the above-mentioned solution of electrical connector, optionally, the substrate of the TPA device includes a mounting substrate and an actuation substrate, said actuation substrate has a thickness to apply a force to the first housing clamping arm configured to bend the same.

In the above-mentioned solution of electrical connector, optionally, interference protrusion is formed on the actuation substrate of the TPA device, so as to apply interference to electrical terminal in the first terminal cavity so as to prevent the electrical terminal from exiting.

In the above-mentioned solution of electrical connector, optionally, the interference protrusion on the actuation substrate includes a first interference protrusion formed at central section of the actuation substrate.

In the above-mentioned solution of electrical connector, optionally, the interference protrusion on the actuation substrate further includes a second interference protrusion formed at an edge of the substrate opposite to the extension pressing arm.

In the above-mentioned solution of electrical connector, optionally, the plastic housing of the shell component include a left sidewall and a right sidewall at its rear portion, and the first housing clamping arms are extending from the left sidewall and the right sidewall, towards the mating side of the electrical connector.

In the above-mentioned solution of electrical connector, optionally, the plastic housing of the shell component include an upper sidewall and a lower sidewall at its rear portion, and the second housing clamping arms are extending from the upper sidewall and the lower sidewall, towards the mating side of the electrical connector.

In the above-mentioned solution of electrical connector, optionally, two clamping arms are formed at both sides of the mounting substrate to clamp the TPA device onto the plastic housing.

### BRIEF DESCRIPTION OF THE DRAWINGS

In order to provide a clearer explanation of the technical solution in the embodiments of the present application, a brief introduction will be given to the drawings to be used for depicting the embodiments.

FIG. 1 is a perspective view of an electrical connector according to some embodiments.

FIG. 2 is a side view of an electrical connector according to some embodiments.

FIG. 3 is a cross-sectional view taken along line A-A in FIG. 2 according to some embodiments.

FIG. 4 is a sectional view taken along line B-B in FIG. 2 according to some embodiments.

FIG. 5 is a front view of an electrical connector according to some embodiments.

FIG. 6A is a sectional view taken along line C-C in FIG. 5 according to some embodiments.

FIG. 6B is a rear half of an electrical connector when the electrical connector is cut into a front half and a rear half according to some embodiments.

FIG. 7 is a perspective view of the exploded structure of an electrical connector according to some embodiments.

FIG. 8 is a perspective view of the shell component in an electrical connector according to some embodiments.

FIG. 9 shows the relative position diagram of two terminal position assurance components in an electrical connector according to some embodiments.

FIG. 10 is a perspective view of a terminal position assurance component according to some embodiments.

### DETAILED DESCRIPTION

The following will, with reference to the accompanying drawings for the embodiments, provide a clear and complete description of the technical solution of the present application. Obviously, the embodiments being depicted are only a part of the embodiments of the present application, not all of them. Based on the embodiments being depicted in this application, all other implementations that would be obtained by those skilled in the art without creative labor are within the scope of protection of this application.

In the description of this application, it should be understood that the terms “center”, “up”, “down”, “front”, “back”, “left”, “right”, “vertical”, “horizontal”, “top”, “bottom”, “inside”, “outside” and other directional or positional relationships indicated are based on the accompanying drawings and are only for the convenience of describing this application and simplifying the description, and do not indicate or imply that the device or component referred to must have such a specific orientation, be constructed and operated in such a specific orientation, and therefore these terms shall not be understood as a limitation of this application.

The terms ““first” and “second” are only used for descriptive purposes and shall not be understood as indicating or implying relative importance or implying the number of technical features indicated. Thus, a feature being defined by “first” and “second” may explicitly or implicitly include one or more additional such features. In the description of this application, unless otherwise specified, the meaning of “multiple” refers to two or more.

In the description of this application, it should be noted that unless otherwise specified and limited, the terms “install”, “connect”, and “couple” should be broadly understood, for example, they may refer to fixed connections, detachable connections, or integral connections; they may refer to a mechanical connection, a direct connection, an indirect connection through an intermediate medium, or an internal communication between two components. For those skilled in the art, the specific meanings of the above terms in this application may be understood according to specific situations.

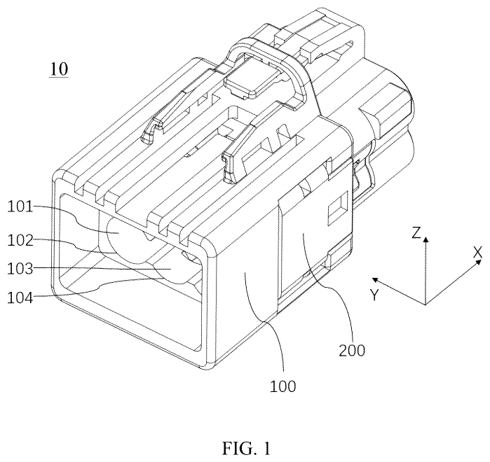

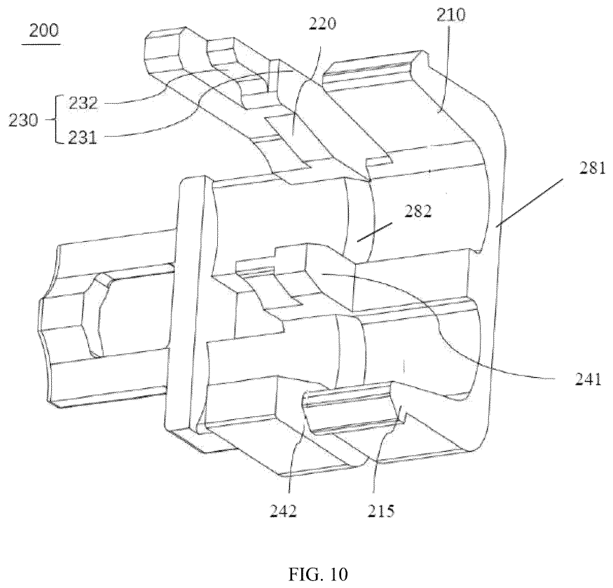

With reference to FIG. 1, an electrical connector, hereafter referred to as connector 10, is proposed according to an embodiment of this application. The connector 10 is configured to contain several electrical terminals. As shown in FIG. 10, the connector 10 can be placed within a XYZ coordination system, wherein the direction of cable extension is assumed to be the first direction X. The first direction X, the second direction Y and the third direction Z are intersecting with each other, for example, they are set perpendicular to each other.

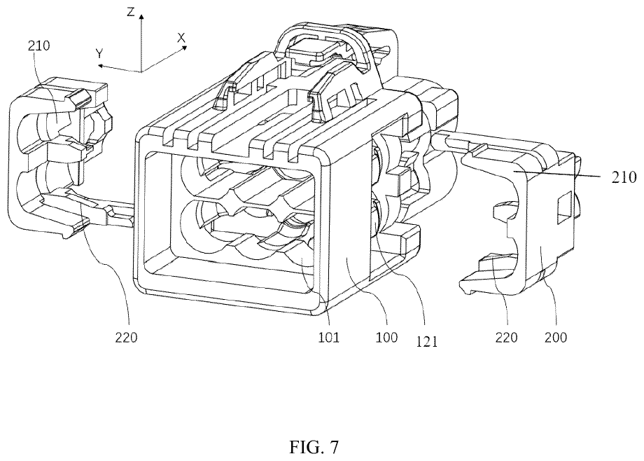

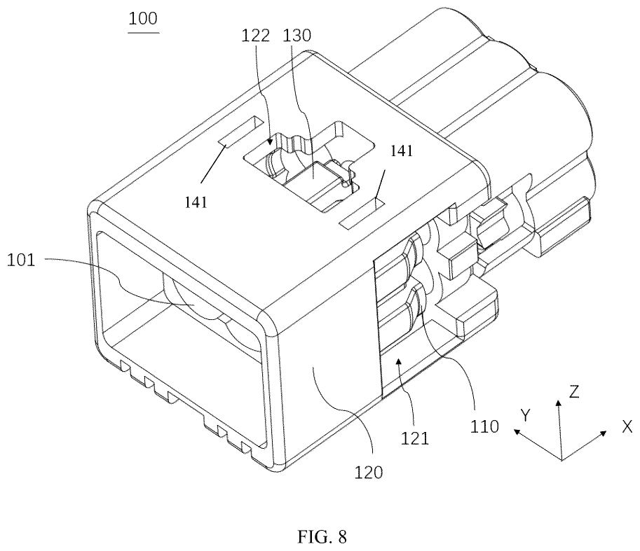

With reference to FIGS. 1 and 7, an electrical connector 10 according to an embodiment of the present application includes shell component 100 and terminal position assurance TPA device 200. As shown in FIGS. 1-3, 6A-6B, and 7, several first terminal cavities 101 are provided within the shell component 100. The first terminal cavity 101 extends from the wire entrance end (rear end) of the connector to the mating end (front end) of the connector and is configured to contain the electrical terminal and keep the electrical terminal in position. At the rear portion (adjacent to wire entrance end of the connector) of the first terminal cavity 101, each first terminal cavity 101 may be partially surrounded by a first inner wall protrusion structure 102. As shown in FIG. 8, the shell component 100 may be or include a plastic housing 120, the rear portion of the plastic housing 120 may be encased by plastic sidewalls, and at the middle portion of the plastic housing 120, there are first housing clamping arms 110 which are extending from the left plastic sidewall and the right plastic sidewall, towards the mating end of the connector. Due to application of an external force, the first housing clamping arm 110 can be deformed or bent towards to inside of the plastic housing 120. In some embodiments, when no force is applied, at least a part of the first housing clamping arm 110 already enters into the first terminal cavity 101.

With reference to FIGS. 1, 4, and 8, a second terminal cavity 103 is also provided within the shell component 100. The second terminal cavity 103 extends from the wire entrance end of the connector to the mating end of the connector and is configured to contain the electrical terminal and keep the electrical terminal in position. At the rear portion (adjacent to wire entrance end of the connector) of the second terminal cavity 103, each second terminal cavity 103 may be partially surrounded by a second inner wall protrusion structure 104. As shown in FIG. 8, at the middle portion of the plastic housing 120, there are second housing clamping arms 130 which are extending from the top (upper) plastic sidewall and the bottom (lower) plastic sidewall, towards the mating end of the connector. Due to application of an external force, the second housing clamping arm 130 can be deformed or bent towards to inside of the plastic housing 120. In some embodiments, when no force is applied, at least a part of the second housing clamping arm 130 already enters into the second terminal cavity 103.

As shown in FIGS. 1 and 7, when there are six terminal positions arranged in two rows, each of the upper row and the lower row includes one second terminal cavity 103, and each second terminal cavity 103 is located between two first terminal cavities 101. It is appreciated that, in more general implementation having an upper row termination position and a lower row termination position, the first terminal cavity can be a terminal cavity adjacent to left plastic sidewall or right plastic sidewall, and the second terminal cavity can be not adjacent to any of left plastic sidewall and right plastic sidewall. For example, when there are eight terminal positions arranged in one upper row and one lower row, the terminal positions #1 and #4 in upper row and terminal positions #5 and #8 in lower row correspond to the first terminal cavities; the terminal positions #2 and #3 in upper row and terminal positions #6 and #7 in lower row correspond to the second terminal cavities.

As shown in FIGS. 7-10, TPA device 200 is configured to be mounted onto the shell component 100 to provide the intended function of terminal position assurance. As shown in FIG. 10, the TPA device 200 includes a mounting section 210 and an actuation section 220, both of which are sharing a substrate 280. For ease of description, the part of substrate 280 corresponding to mounting section 210 is referred to as mounting substrate 281, and the part of substrate 280 corresponding to actuation section 220 is referred to as actuation substrate 282. The mounting section 210 includes the mounting substrate 281 and a pair of clamping arms 215. With this pair of clamping arms 215, the TPA device 200 can be mounted onto the mounting notch 121 formed on lateral side of the shell component 100. As shown in FIG. 8, at the bottom side of the plastic housing 120, there are a pair of clutch slots 141 configured to be engaged with clutch edge at end of the clamping arm 215, so as to achieve mounting of TPA device 200 at pre-lock stage. At the bottom side of the plastic housing 120, there is also a central opening 122, to achieve mounting of TPA device 200 at final-lock stage. Although not shown, it is appreciated that at the top side of the plastic housing 120 there are similar clutch slots and central opening.

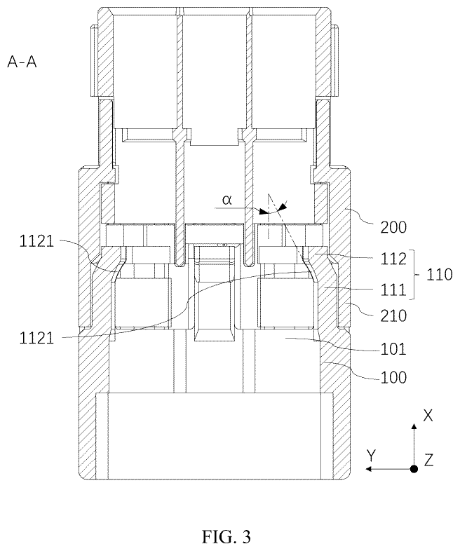

As further shown in FIG. 10, TPA device 200 further includes an actuation section 220 adjacent to the mounting section 210. The actuation section is configured such that, when it is mounted onto the shell component 100, it may apply a force to both the first housing clamping arm 110 and the second housing clamping arm 130 in the shell component 100, such that a locking or position assurance effect is applied. In particular, as shown in FIG. 10, the actuation section 220 is adjacent to the mounting section 210. The actuation section 220 includes an actuation substrate 282 and structures formed on the actuation substrate 282. As compared to the mounting substrate 281, the actuation substrate 282 has an increased thickness. As shown in FIG. 3, when the TPA device 200 is mounted onto left and right sides of the shell component 100, the actuation substrate 282 with increased thickness will press the first housing clamping arms 110 formed on left and right sides of the plastic housing 120, such that the first housing clamping arm 110 will be deformed, to make the first free end 112 further approach the axial center of the first terminal cavity 101, so as to enhance the retention force applied by the first housing clamping arm 110 to the electrical terminal.

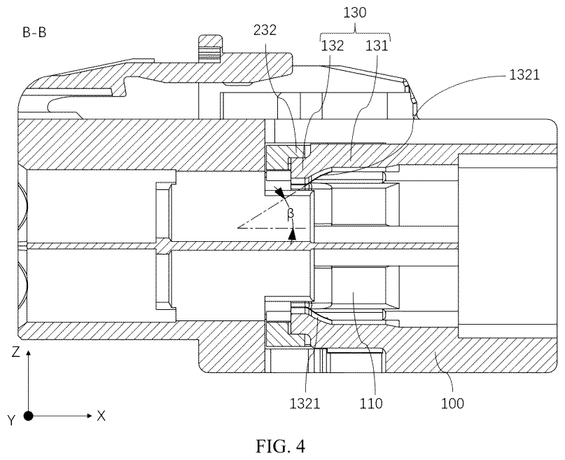

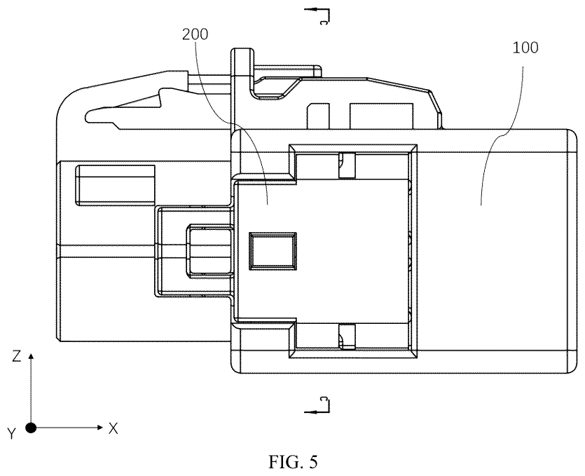

With further reference to FIGS. 4 and 9-10, the actuation section 220 of the TPA device 200 includes an extension pressing arm 230 extending from an edge of the actuation substrate 282. The extension pressing arm 230 includes an extension connecting plate 231 and a pressing part 232 at end of the extension connecting plate 231, and the pressing part 232 has a position and structure to press the second housing clamping arm 130 at upper side or lower side of the plastic housing 120, such that the second housing clamping arm 130 will be deformed, to make the second free end 132 further approach the axial center of the second terminal cavity 103, so as to enhance the retention force applied by the second housing clamping arm 130 to the electrical terminal.

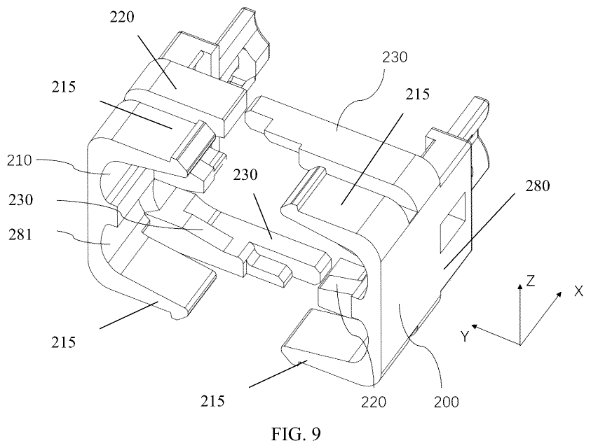

In some embodiments, as shown in FIGS. 9-10, the width and thickness of the pressing part 232 is less than the width and thickness of the extension connecting plate 231, such that the overall strength of the extension pressing arm 230 can be ensured.

The actuation section 220 of the TPA device 200 may include two interference protrusions separate from the extension pressing arm 230. As shown in FIG. 10, two interference protrusions may include a first interference protrusion 241 formed at central part of the actuation substrate 282, and a second interference protrusion 242 formed at an edge of the actuation substrate 282 opposite to the extension pressing arm 230.

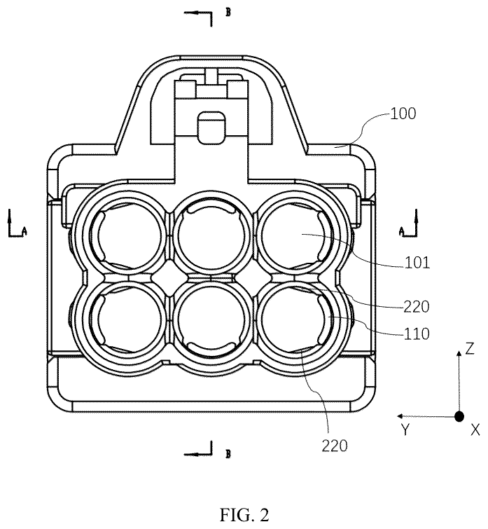

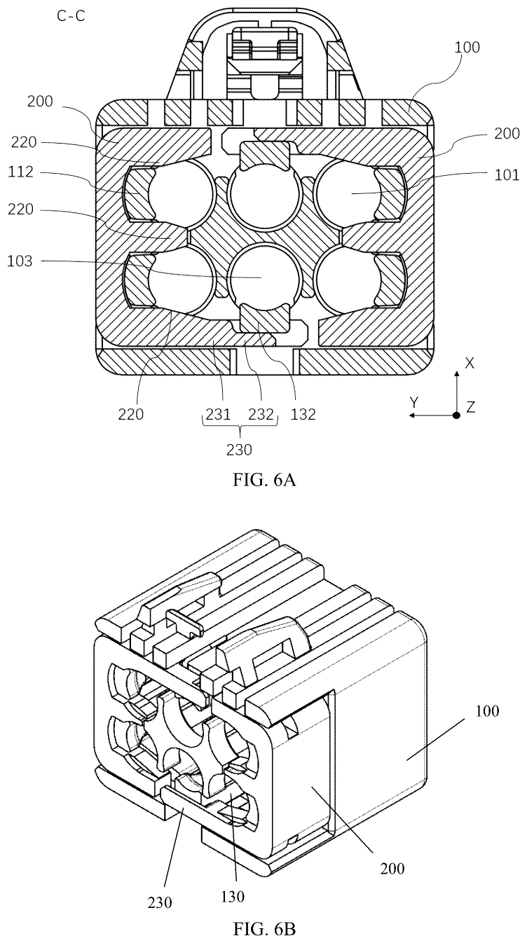

Comparing FIG. 2 with FIG. 6A, it can be seen than, along the first direction X, the projections of the first interference protrusion 241 and the second interference protrusion 242 would partially overlap with the projection profile of the first terminal cavities, such that the first interference protrusion 241 and the second interference protrusion 242 may prevent the electrical terminals in the first terminal cavities 101 from exiting by physical interference.

Comparing FIG. 2 with FIGS. 6A and 6B, for the electrical terminal in the second terminal cavities (i.e., the middle electrical terminal in the upper row, the middle electrical terminal in the lower row), although a position assurance based on physical interference (similar to the physical interference for the first terminal cavity) can be absent, the pressing part 232 of the extension pressing arm 230 may apply a force to the second free end 132 of the second housing clamping arm 130, such that the second housing clamping arm 130 will have a deformation towards the inside of the plastic housing 120, enhancing the retention force for electrical terminals in the second terminal cavities.

In another embodiment, as shown in FIG. 3, the first connecting plate 111 of the first housing clamping arm 110 is connected to the first inclined surface 1121, and the first inclined surface 1121 is connected to the first free end 112. In a final-lock state (the electrical terminal being locked), the first inclined surface 1121 has a first inclination angle α between it and the first direction X. The range of the first inclination angle α is 30° to ˜60°. In specific implementation, the first inclination angle α can also be selected as any value from 30°, 35°, 40°, 45°, 50°, or 55°, 60°, or within a range of any two preceding values.

In another embodiment, as shown in FIG. 4, the second connecting plate 131 of the second housing clamping arm 130 is connected to the second inclined surface 1321, and the second inclined surface 1321 is connected to the second free end 132. In a final-lock state (the electrical terminal being locked), the second inclined surface 1321 has a second inclination angle β between it and the first direction X. The range of the second inclination angle β is 30° to ˜60°. In specific implementation, the second inclination angle β can also be selected as any value from 30°, 35°, 40°, 45°, 50°, or 55°, 60°, or within a range of any two preceding values.

This application provides a detailed introduction to a connector provided in the embodiments of the present application. Specific examples are provided to explain the principles and implementation methods of the present application. The above embodiments are only used to help understand the method and core idea of the present application. Meanwhile, for a person skilled in the art, based on the ideas of this application, changes in the specific implementation approaches are possible. Therefore, the content of this specification should not be understood as limiting this application.

1. An electrical connector, comprising:
a shell component having a plurality of terminal cavities configured to contain electrical terminals, wherein the shell component includes a plastic housing formed with multiple housing clamping arms corresponding to the plurality of terminal cavities respectively, wherein the multiple housing clamping arms comprises a first housing clamping arm formed on a left side and a right side of the plastic housing, and a second housing clamping arm formed on an upper side and a lower side of the plastic housing; and
a terminal position assurance (TPA) device configured to be mounted onto the left side and the right side of the plastic housing of the shell component, wherein each TPA device is configured to apply a force to both the first housing clamping arm and the second housing clamping arm, such that both the first housing clamping arm and the second housing clamping arm are deformed towards an inside of the plastic housing.

2. The electrical connector of claim 1, wherein the plurality of terminal cavities comprise a first terminal cavity and a second terminal cavity, wherein the first housing clamping arm is provided adjacent the first terminal cavity, and the second housing clamping arm is provided adjacent the second terminal cavity.

3. The electrical connector of claim 2, wherein the TPA device is configured to push the first housing clamping arm configured to bend so as to enter into the first terminal cavity and is further configured to push the second housing clamping arm configured to bend so as to enter into the second terminal cavity.

4. The electrical connector of claim 2, wherein the plurality of terminal cavities comprise an upper row and a lower row, each row of terminal cavities comprise a first terminal cavity at a leftmost position, a first terminal cavity at a rightmost position, and a second terminal cavity between the first terminal cavities.

5. The electrical connector of claim 4, wherein the plurality of terminal cavities comprise six terminal cavities arranged in upper row and lower row and wherein each row of three terminal cavities comprise a first terminal cavity at the leftmost position, a first terminal cavity at the rightmost position, and a second terminal cavity at a middle position.

6. The electrical connector of claim 1, wherein the TPA device comprises a first TPA device configured to be mounted on the left side of the plastic housing of the shell component, and a second TPA device configured to be mounted on the right side of the plastic housing of the shell component, the first TPA device is configured to push a second housing clamping arm on one of the upper side and lower side of the plastic housing and the second TPA device is configured to push a second housing clamping arm on another one of the upper side and lower side of the plastic housing.

7. The electrical connector of claim 2, wherein the TPA device is configured to apply interference to a terminal in the first terminal cavity so as to prevent the terminal from exiting the first terminal cavity.

8. The electrical connector of claim 1, wherein the TPA device comprises a substrate and an extension pressing arm formed at an edge of the substrate and wherein the extension pressing arm is configured to apply a force configured to bend the second housing clamping arm when the substrate of the TPA device is mounted at a left side or right side of the plastic housing.

9. The electrical connector of claim 8, wherein the substrate of the TPA device comprises a mounting substrate and an actuation substrate and wherein the actuation substrate has a thickness sufficient to apply a force configured to bend the first housing clamping arm.

10. The electrical connector of claim 8, wherein interference protrusion is formed on an actuation substrate of the TPA device and is configured to apply interference to terminal in the first terminal cavity so as to prevent the terminal from exiting the first terminal cavity.

11. The electrical connector of claim 10, wherein the interference protrusion on the actuation substrate comprises a first interference protrusion formed in a central section of the actuation substrate.

12. The electrical connector of claim 11, wherein the interference protrusion on the actuation substrate further comprises a second interference protrusion formed at an edge of the substrate opposite to the extension pressing arm.

13. The electrical connector of claim 1, wherein the plastic housing of the shell component comprises a left sidewall and a right sidewall at its rear portion and wherein the first housing clamping arms extend from the left sidewall and the right sidewall towards a mating side of the electrical connector.

14. The electrical connector of claim 1, wherein the plastic housing of the shell component comprises an upper sidewall and a lower sidewall at its rear portion and wherein the second housing clamping arms extend from the upper sidewall and the lower sidewall, towards a mating side of the electrical connector.

15. The electrical connector of claim 9, wherein two clamping arms are formed at both sides of the mounting substrate to clamp the TPA device onto the plastic housing.
